(19) United States
(12) Patent Application Publication
(10) Pub. No.: US 2005/0273246 A1
(43) Pub. Date: Dec. 8, 2005

(54) Bi-fuel converter device for automobiles and internal combustion engines

(76) Inventor: Frederico Griese, Campinas-Sao Paulo (BR)

Correspondence Address: TRASK BRITT, P.O. BOX 2550, SALT LAKE CITY, UT, 84110, US

(21) Appl. No.: 10/973,184

(22) Filed: Oct. 25, 2004

(30) Foreign Application Priority Data
Jun. 6, 2004 (BR) PI 0402326-9

(51) Int. Cl. F02D 41/28

(52) U.S. Cl. 701/113; 701/115; 123/491

(57) ABSTRACT

“BI-FUEL CONVERTER DEVICE FOR AUTOMOBILES AND INTERNAL COMBUSTION ENGINES”. A new bi-fuel converter device for automobiles and internal combustion engines with electronic injection, which has the objective to make the vehicle or internal combustion engine capable of operating with more than two different fuels, alternately and/or simultaneously, without suffering failures or significant differences in operation due to the fuel change, without altering the original situation of the vehicle or engine.

### BACKGROUND OF THE INVENTION

The present invention refers to a bi-fuel converter device for automobiles and internal combustion engines with electronic injection, which has the objective to make the vehicle or internal combustion engine capable of operating with more than two different fuels, alternately and/or simultaneously, without suffering failures or significant differences in operation due to the fuel change, without altering the original situation of the vehicle or engine.

Presently, the fuel conversion or bi-fuel systems significantly alter the original situation of the vehicle or engine, and their installation is made by changing the chip at the injection center, injection nozzles, spark plugs and installing systems that “cheat” the engine sensors and others. The present systems have the inconvenience of not being very efficient, besides losing the original situation, for they generally fail, overheat the engines, promote a significant increase in fuel usage and also promote failures in engine operation. In the present systems, conversion from one fuel to another is done by changing the fuel and the components with which the vehicle or engine will operate; this conversion is irreversible. Effectively, there is no product on the market for bi-fuel conversion of vehicles originally manufactured for one fuel.

To solve these inconveniences, the present invention was developed; its installation on the automobile or engine is made without cutting wires, changing nozzles and spark plugs, changing chips and installing systems to cheat sensors. Installation is made only using connectors which are compatible with the automobile or engine where it is installed; therefore, installation and de-installation is fast and does not alter the original situation of the automobile and/or engine.

Below there are references to the figures that accompany this descriptive report, for its better understanding and illustration, where one may see:

### BRIEF DESCRIPTION OF THE SEVERAL VIEWS OF THE DRAWINGS

FIG. 1 shows the bi-fuel converter, presenting all its configuration details.

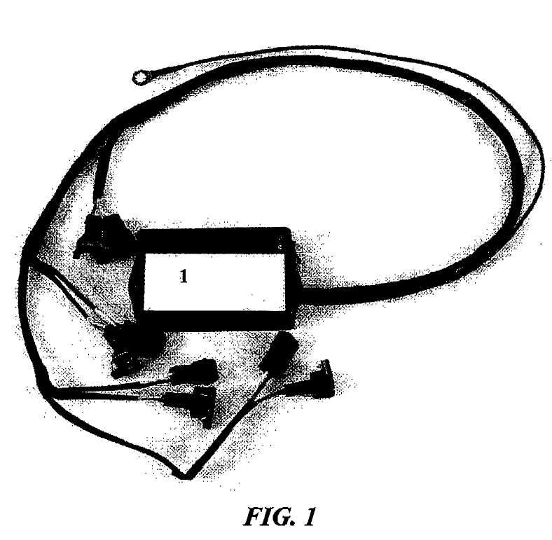

FIG. 2 shows a block diagram of the operation and application of the bi-fuel converter.

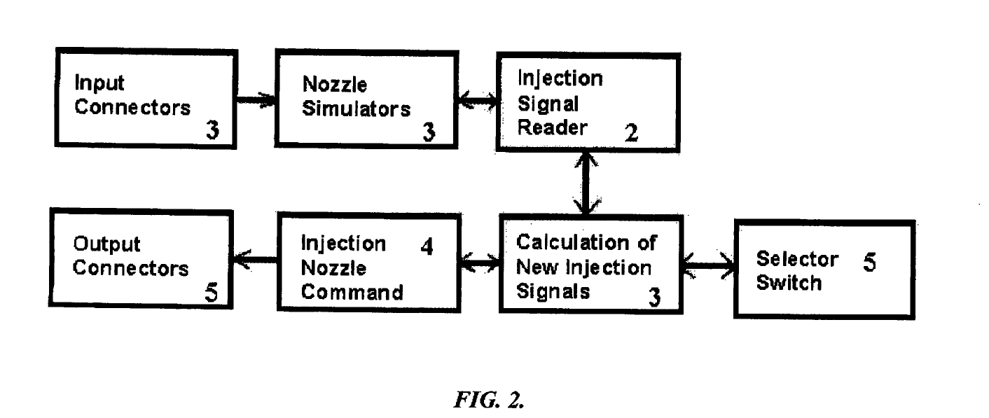

### DETAILED DESCRIPTION OF THE INVENTION

The bi-fuel converter for automobiles and internal combustion engines, the object of the present patent request, is a system which automatically corrects fuel mixtures or operations with different fuels, therefore becoming a flexible system for the user, who may operate the vehicle or engine with various fuels, one at a time or with a mixture of the two, without damaging the engine or causing significant variations in its operation.

The bi-fuel converter (1) for automobiles and internal combustion engines, the object of the present patent request, is essentially composed of five distinct main components, as follows: a Reader of the original engine parameters (2), which is a circuit that intercepts and interprets the engine operating parameters and sends them to a center (3) that recalculates the new parameters; a Center (3) to recalculate the engine operating parameters and furnish new parameters, that will be delivered to a circuit (4) that generates the new corrected parameters to the engine; a Circuit (4) to generate parameters which are compatible with the engine, recalculated by the center (3); a Mechanical component (5), composed by a box, a selector switch, cables and connectors compatible with the engine; a Logical system for cold starting, that allows the user to start the engine at low temperatures without the need to inject gasoline, in the case of using pure alcohol. This device is not present in vehicles originally manufactured as bi-fuel.

The bi-fuel converter for automobiles and internal combustion engines, the object of the present patent request, has various advantages; among them, one can mention the ease and speed of installation, maintaining the original situation of the engine, for this device does not alter cables, sensors, chips and electronic centers, does not alter the original situation of the engine or vehicle. Its use makes the engine flexible in relation to fuels, for the engine can operate with gasoline, alcohol or a mixture of the two. It does not alter vehicle performance. Besides this, this equipment or device was specially developed for vehicles or engines originally one-fuel, to be compatible with all engines and vehicles with electronic injection.

Therefore, by the above description of the configuration, application and operation, one can clearly note that the “BI-FUEL CONVERTER DEVICE FOR AUTOMOBILES AND INTERNAL COMBUSTION ENGINES”, is an unprecedented equipment and/or device for our Present Technical Status that deserves the privilege of being granted a Patent for Invention.

1. “BI-FUEL CONVERTER DEVICE FOR AUTOMOBILES AND INTERNAL COMBUSTION ENGINES”, characterized by being essentially composed of five distinct main components, as follows: a Reader of the original engine parameters (2), which is a circuit that intercepts and interprets the engine operating parameters and sends them to a center (3) that recalculates the new parameters; a Center (3) to recalculate the engine operating parameters and furnish new parameters, that will be delivered to a circuit (4) that generates the new corrected parameters to the engine; a Circuit (4) to generate parameters which are compatible with the engine, recalculated by the center (3); a Mechanical component (5), composed by a box, cables and connectors compatible with the engine; a Logical system for cold starting, that allows the user to start the engine at low temperatures without the need to inject gasoline, in the case of using pure alcohol.
